(19) United States
(12) Patent Application Publication
(10) Pub. No.: US 2010/0256824 A1
(43) Pub. Date: Oct. 7, 2010

(54) ENVIRONMENTAL CONTROL DEVICE

(75) Inventors: Vadim VAL-KHVALABOV, Chicago, IL (US); Javad M. Vakil, Morton Grove, IL (US); John E. Bussan, Naperville, IL (US); Jeffrey R. Rendlen, Glen Ellyn, IL (US); Michael R. Nelson, Libertyville, IL (US); John Moskal, Chicago, IL (US)

Correspondence Address: FOLEY AND LARDNER LLP;SUITE 500, 3000 K STREET NW, WASHINGTON, DC, 20007, US

(73) Assignee: Nanolnk, Inc.

(21) Appl. No.: 12/718,753

(22) Filed: Mar. 5, 2010

Related U.S. Application Data
(60) Provisional application No. 61/158,291, filed on Mar. 6, 2009.

(51) Int. Cl. G05D 23/19; G05D 7/06

(52) U.S. Cl. 700/282

(57) ABSTRACT

Improved environmental control system for improved nanolithography, imaging, detecting, and fabricating. An article comprising: at least one environmental chamber; at least one conditioning chamber adapted to be in gaseous communication with the environmental chamber, wherein the conditioning chamber comprises at least one gas transport device such as a fan, optionally at least one temperature probe, and at least one heating-cooling device such as a thermoelectric device which in operation provides a cold side and a hot side, at least one water vapor source, and at least one temperature sensor, at least one humidity sensor, wherein the fan, the thermoelectric device, the water vapor source, the temperature sensor, and the humidity sensor are adapted for a temperature controlled and humidity controlled gaseous flow. Two fans can be used, wherein the fans can transport air in the same direction or in opposite directions.

### RELATED APPLICATIONS

This application claims the priority benefit of U.S. provisional application Ser. No. 61/158,291 filed Mar. 6, 2009 to Val-Khvalabov, et al., which is hereby incorporated by reference in its entirety.

### BACKGROUND

Instruments and methods for imaging, detection, and fabrication have improved so that, increasingly, commercial applications at the microscale and nanoscale are possible. However, despite these advances, a need exists for better control of gaseous environments in processes and instruments for imaging and fabrication such as temperature control and humidity control which allow for improved control tasks such as imaging and patterning. In particular, a need exists to improve nanolithographic fabrication processes.

### SUMMARY

Embodiments described herein include, for example, articles, devices, apparatuses, instruments, software, methods of making, and methods of using.

One embodiment provides an article comprising: at least one environmental chamber; at least one conditioning chamber adapted to be in gaseous communication with the environmental chamber, wherein the conditioning chamber comprises at least one gas transport device, and at least one heating-cooling device which in operation provides a cold side and a hot side, at least one water vapor source, and at least one temperature sensor, at least one humidity sensor, wherein the gas transport device, the heating-cooling device, the water vapor source, the temperature sensor, and the humidity sensor are adapted for a temperature controlled and humidity controlled gaseous flow in the environmental chamber.

The heating-cooling device can comprise a thermoelectric device. The gas transport device can comprise a fan. The water vapor source can comprise a water heater. The water vapor source can comprise a water heater evaporation chamber in fluidic communication with a water heater reservoir, the water heater evaporation chamber further comprising a resistive heating element electrically connected to a temperature switch. The conditioning chamber can comprise at least one gas transport device which is a fan, and at least one heating-cooling device which is a thermoelectric heater. The conditioning chamber can comprise at least two gas transport devices which are fans, and at least two heating-cooling devices which are thermoelectric heaters. The environmental chamber and the conditioning chamber can be connected by at least one gas connector which provides the gaseous communication. The environmental chamber and the conditioning chamber can be connected by at least two gas connectors which each provide the gaseous communication. The gas connectors can be made of flexible materials to provide vibration isolation between the environmental chamber and the conditioning chamber. An operating device can be disposed in the environmental chamber and can be subject to the temperature controlled and humidity controlled gaseous flow in the environmental chamber. The environmental chamber can be not hermetically sealed and the conditioning chamber can be not hermetically sealed. The temperature sensor can be a high resolution temperature sensor. The conditioning chamber can comprise at least one valve adapted to decrease humidity in a gaseous flow. An operating device can be disposed in the environmental chamber which can be adapted for patterning, nanolithography, detection, imaging, or a combination thereof. The environmental chamber can comprise a removable cover. The environmental chamber and conditioning chamber together can comprise a volume less than about 200 cubic cm. The article can be adapted for substantially continuous gaseous exchange between the environmental chamber and the conditioning chamber. The article can be adapted for a flow of air in a cooling mode and a flow of air in a heating mode. The article can be adapted to function with a computer and a user interface. The temperature sensor and the humidity sensor can be disposed in the environmental chamber. A first gas transport device and a second gas transport device can be each disposed between a first heating-cooling device and a second heating-cooling device. The conditioning chamber can comprise at least 8 gas transport devices which are fans, with 4 of the 8 fans being external fans and the other 4 fans being internal fans, and at least four heating-cooling devices which are thermoelectric heaters. A temperature probe can be attached to a respective one of the at least four thermoelectric heaters. A temperature probe can be attached to two of the at least four thermoelectric heaters. A temperature switch can be attached to a respective one of the at least four thermoelectric heaters. A temperature switch can be attached to two of the at least four thermoelectric heaters. Two of the temperature probes and two of the temperature switches may be disposed at an internal or inner portion of the conditioning chamber and two of the temperature probes may be disposed at an external or outer portion of the conditioning chamber.

Another embodiment provides an article comprising: at least one environmental chamber; at least one conditioning chamber adapted to be in gaseous communication with the environmental chamber, wherein the conditioning chamber comprises at least one gas transport device, and at least one heating-cooling device which in operation provides a cold side and a hot side, at least one water vapor source, and at least one temperature sensor, at least one humidity sensor, wherein the gas transport device, the heating-cooling device, the water vapor source, the temperature sensor, and the humidity sensor are adapted for a temperature controlled gaseous flow in the environmental chamber.

Another embodiment provides an article comprising: at least one environmental chamber; at least one conditioning chamber adapted to be in gaseous communication with the environmental chamber, wherein the conditioning chamber comprises at least one gas transport device, and at least one heating-cooling device which in operation provides a cold side and a hot side, at least one water vapor source, and at least one temperature sensor, at least one humidity sensor, wherein the gas transport device, the heating-cooling device, the water vapor source, the temperature sensor, and the humidity sensor are adapted for a humidity controlled gaseous flow in the environmental chamber.

Another embodiment provides an article comprising: at least one environmental chamber at least one conditioning chamber adapted to be in gaseous communication with the environmental chamber, wherein the conditioning chamber comprises at least one fan and at least one thermoelectric device, at least one water vapor source, which can be disposed in the environmental chamber or the conditioning chamber, and at least one temperature sensor disposed in the environmental chamber, at least one humidity sensor disposed in the environmental chamber, wherein the environmental chamber is adapted to function with at least one operation area disposed in the environmental chamber; wherein the fan, the thermoelectric device, the water vapor source, the temperature sensor, and the humidity sensor are adapted for a temperature controlled and humidity controlled gaseous flow at the operation area in the environmental chamber.

The article can comprise at least two fans. The article can comprise at least two thermoelectric devices and at least two temperature probes associated with the two thermoelectric devices. The article can comprise at least 8 fans, with 4 of the 8 fans being external fans and the other 4 fans being internal fans. The article can comprise at least four thermoelectric heaters attached to temperature probes and temperature switches. An operation device can be disposed in the environmental chamber and subjected to temperature and humidity controlled gaseous flow. The article can be adapted for use with a nanolithography instrument. The article can be adapted to function with a computer and a user interface. The volume of the environmental chamber and conditioning chamber combined can be about 200 cc or less. The thermoelectric device can be capable of acting as a heater when operated with a first electrical polarity and as a cooler when operated with a second electrical polarity, said second polarity being of opposite the first electrical polarity.

Another embodiment provides an instrument comprising: at least one conditioning chamber, at least one environmental chamber, at least one temperature control system, at least one humidity control system, and an operation area, wherein the chambers and systems are adapted for closed loop control via software to control temperature and humidity during an operation in the operation area.

The instrument can be adapted to function with a system comprising a microscope. The instrument can be adapted to function with a patterning system. The instrument can be adapted to function with a nanolithography system.

Another embodiment provides a method comprising: providing an operation area and gaseous flow over the operation area, wherein the gaseous flow controls the temperature and humidity of the operation area, wherein the gaseous flow is provided by at least one gas transport device in continuous operation for cooling and heating and adapted to function with at least one heating-cooling device, and at least one water vapor source.

The gaseous flow can be provided by two fans, wherein only one of said two fans is in operation at a given time, and each of said two fans provides gaseous flow in opposite directions when in operation. Or, the gaseous flow can be provided by two fans, wherein the two fans are in operation at the same time, and each of said two fans provides gaseous flow in the same direction when in operation. The gaseous flow can be provided by one fan, and said fan is capable of providing gaseous flow in a first direction when operated with a first electrical polarity and said fan capable of providing gaseous flow in a second direction when operated with a second electrical polarity, said second polarity being opposite said first polarity.

In one embodiment, a dry gas source such as dry nitrogen gas can be also used to control humidity. In one embodiment, a solenoid valve can be used to control flow of dry nitrogen gas or other gases.

At least one advantage for at least one embodiment includes better temperature control and/or better humidity control during an operation such as fabrication, patterning, detection, and/or imaging, which can provide better fabrication, patterning, detection, and/or imaging.

At least one additional advantage is relatively less expense as hermetic sealing is not needed.

At least one additional advantage is relatively less noise during operation.

At least one additional advantage for at least one embodiment is a higher stability of the controlled environment, particularly for a smaller controlled environment, along with continuous air exchange.

At least one additional advantage for at least one embodiment includes better isolation of vibrations due to unidirectional gaseous flow.

At least one additional advantage for at least one embodiment includes providing higher humidity control and large working area for lipid membrane growth.

### BRIEF DESCRIPTION OF THE FIGURES

FIG. 1 illustrates a cross-sectional view of one embodiment for an environmental control device comprising a conditioning chamber and an environmental chamber.

FIG. 2 illustrates a perspective view of one embodiment for a conditioning chamber.

FIG. 3 illustrates a perspective, cut-away view of the inside of one embodiment for a conditioning chamber.

FIG. 4 illustrates a perspective view of one embodiment for an instrument comprising an environmental control device comprising an environmental chamber and a conditioning chamber.

FIG. 5 illustrates one embodiment for a user interface for an automatic mode.

FIG. 6 illustrates one embodiment for a user interface for a manual mode.

FIG. 7 illustrates one embodiment for a user interface for an off mode.

FIG. 8 illustrates a cross-sectional view of another embodiment for an environmental control device comprising a conditioning chamber and an environmental chamber.

FIG. 9 illustrates a perspective view of another conditioning chamber embodiment

FIG. 10 illustrates a perspective cut-away view of the conditioning chamber of FIG. 9.

FIG. 11 illustrates a perspective view of another embodiment for an instrument comprising an environmental control device comprising a conditioning chamber and an environmental chamber.

FIG. 12 illustrates a perspective cut-away view of another embodiment for an instrument comprising an environmental control device comprising a conditioning chamber and an environmental chamber.

FIG. 13 illustrates another embodiment for a user interface during control device startup in manual mode.

FIG. 14 illustrates another embodiment for user interface for a manual mode.

FIG. 15 illustrates another embodiment for user interface for an automatic mode.

### DETAILED DESCRIPTION

### Introduction

All references cited herein are incorporated by reference in their entirety.

TEC means thermoelectric cooler.

An embodiment provides an environmental control system which can provide functionality which includes, for example, closed loop control via software, temperature and humidity display via software, a heating temperature range, a cooling temperature range, temperature stability, a humidity range, and humidity stability.

An environmental control system can comprise at least two chambers, an environmental chamber and a conditioning chamber. In one embodiment, the chambers can be connected by a plurality of flexible airways, such as two airways, forming a closed system with continuous circulation.

### Instrument

An example of an instrument which can be adapted with use of the embodiments described herein for an environmental control device is US Patent Publication 2009/0023607 filed May 9, 2008 to Rozhok et al. (“Compact Nanofabrication Apparatus”) which is hereby incorporated by reference in its entirety including drawings, working examples, and other sections. Nanopositioning and nanolithography is described. Examples of nanopositioning are also found in Hicks et al, The Nanopositioning Book. Moving and Measuring to Better than a Nanometre, 2000.

The instrument can be a patterning instrument and can include devices such as two dimensional arrays of tips and/or high density arrays of tips. An example of a device is described in, for example, US Patent Publication 2009/0325816 filed Dec. 12, 2007 to Mirkin (“Massively Parallel Lithography With Two-Dimensional Pen Arrays), which is hereby incorporated by reference in its entirety including drawings, working examples and other sections.

Other nanolithography instrumentation can be provided by, for example, NanoInk, Inc. (Skokie, Ill.). Lithography and nanolithography can be carried out by polymer pen lithography, using, for example, softer polymer tips as known in the art.

### Exemplary Embodiments

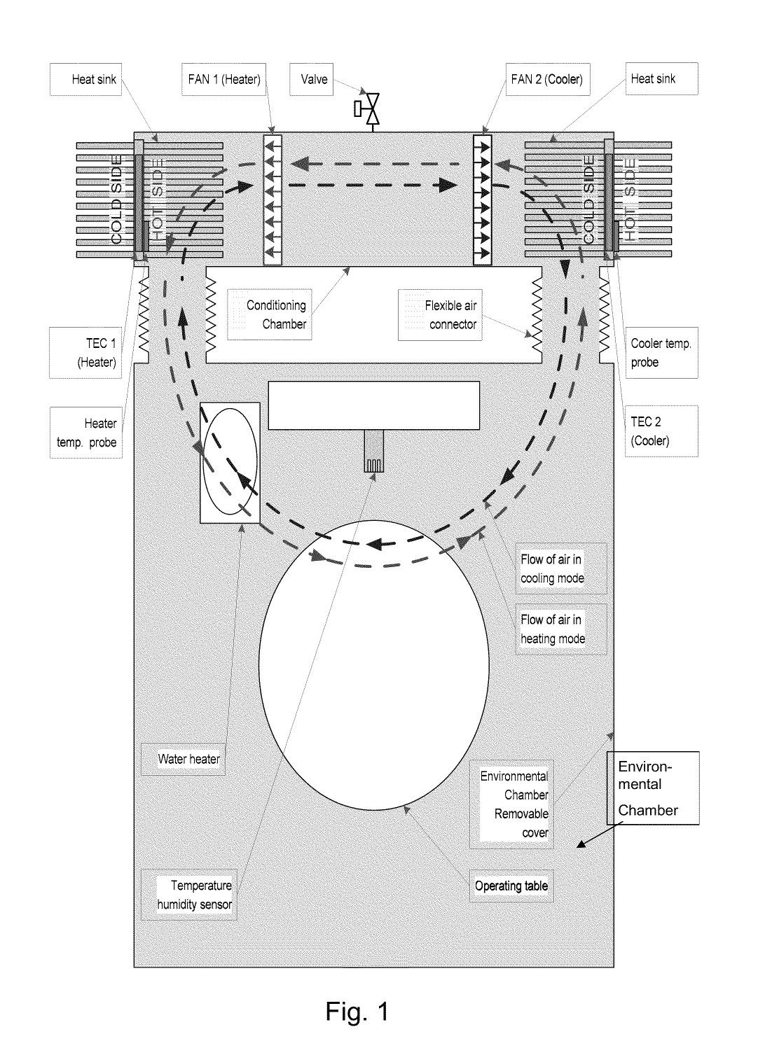

### FIGS. 1-4

FIG. 1 illustrates in cross-section a representative embodiment which comprises features and elements identified and further described herein. Embodiments such as that shown in FIG. 1 can be adapted to function with a larger instrument for fabrication, detection, or imaging.

Elements shown in FIG. 1 include:

A conditioning chamber adapted to function with an environmental chamber, wherein gaseous communication is established between the two chambers by flexible gas or air connectors. The conditioning chamber can provide a volume; the environmental chamber can provide a volume. The volume of the flexible gas or air connectors can be minimized.

TEC 1 is a heating-cooling device, in this case a thermoelectric device, which provides a hot side and a cold side in operation. In FIG. 1, TEC 1 presents a hot side. A heater temperature probe functions together with TEC 1. A heat sink is also provided (fins).

Fan 1 is an example of a gas transport device and is also shown which functions to pass gas or air over the hot side of TEC 1.

TEC 2 is a heating-cooling device, in this case a thermoelectric device, which provides a cold side and a hot side in operation. In FIG. 1, TEC 2 presents a cold side. A cooler temperature probe functions together with TEC 1. A heat sink is also provided (fins).

Fan 2 is an example of a gas transport device and is also shown which functions to pass gas or air over the cold side of TEC 2.

A valve such as a solenoid valve is shown which for lower humidity can be activated so that humidity is decreased. Chamber air is displaced with gas such as nitrogen from an external source via the valve.

An operating table is shown which can be subjected to the flow of gas in a first direction or a second direction as shown by the arrows, the gas circulating between the conditioning chamber and the environmental chamber. The arrows show flow of air in a cooling mode, and flow of air in a heating mode. The operating table can be the site of a process like nanolithography or nanoscopic imaging.

The two fans can transport gas in the same direction or opposite directions.

A temperature humidity sensor is also shown which can sense the environment around the operating table.

A water heater can also be placed in the flow of the gas to help with humidity control.

The environmental chamber can comprise a removable cover.

These and other elements are described in more detail hereinafter.

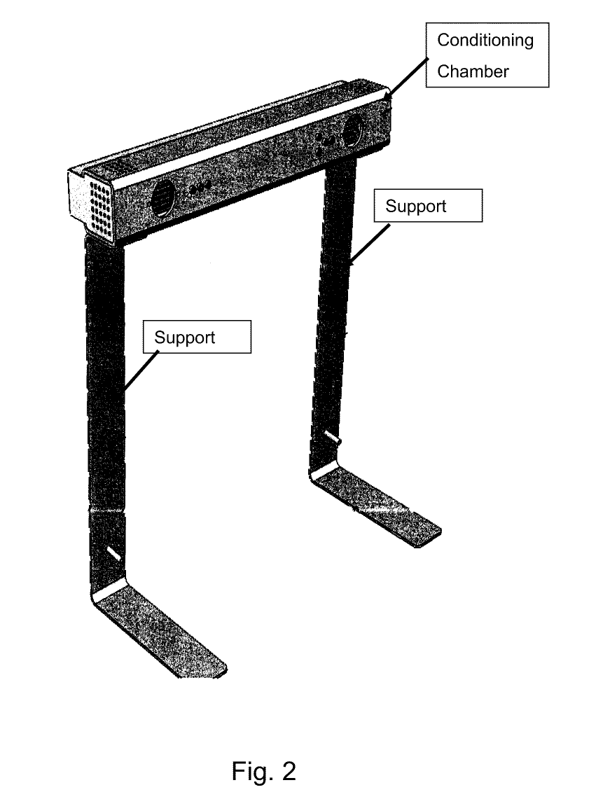

FIG. 2 provides a perspective view of a conditioning chamber. Supports are shown which can be used below the conditioning chamber to position and stabilize the conditioning chamber.

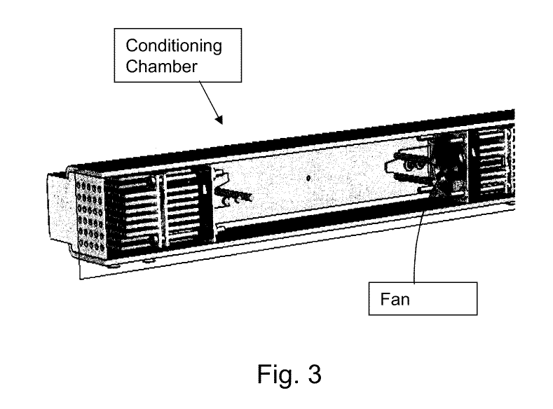

FIG. 3 provides a look into the inside of a conditioning chamber including fan and thermoelectric device.

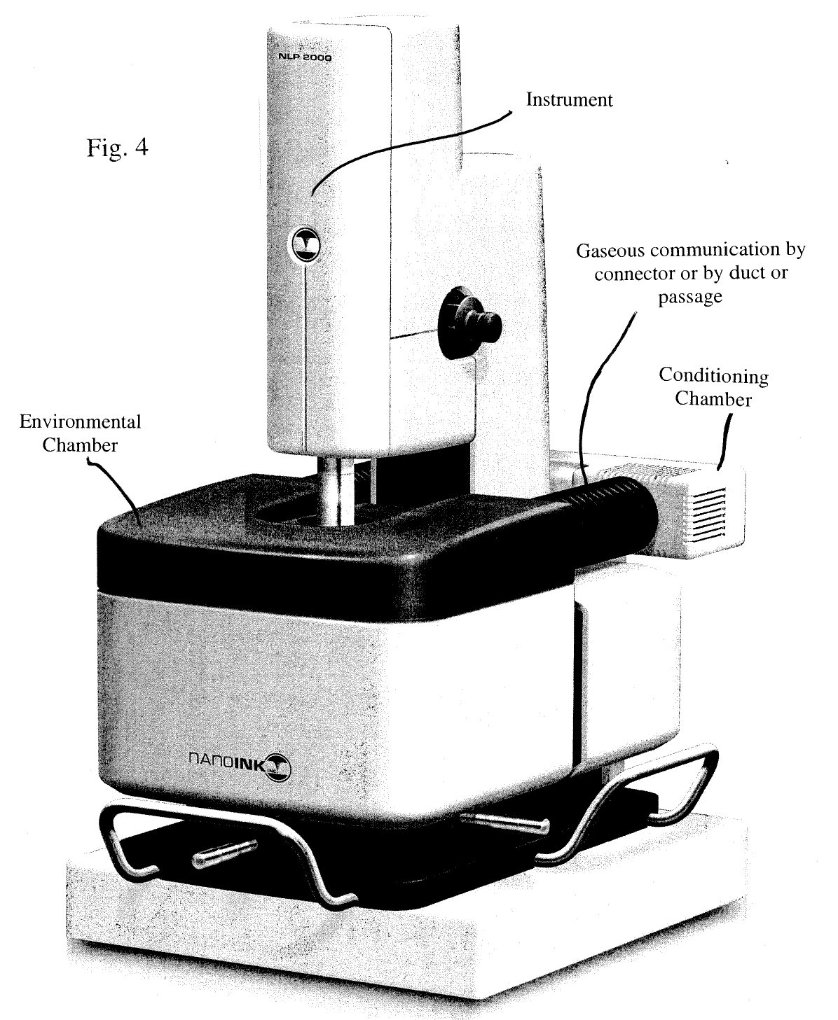

FIG. 4 shows a larger instrument which can be adapted to function with an environmental chamber and a conditioning chamber. The instrument can comprise, for example, optical microscopes to view specimens, and positioning tables to maneuver a specimen relative to a microscope.

### Additional Embodiments

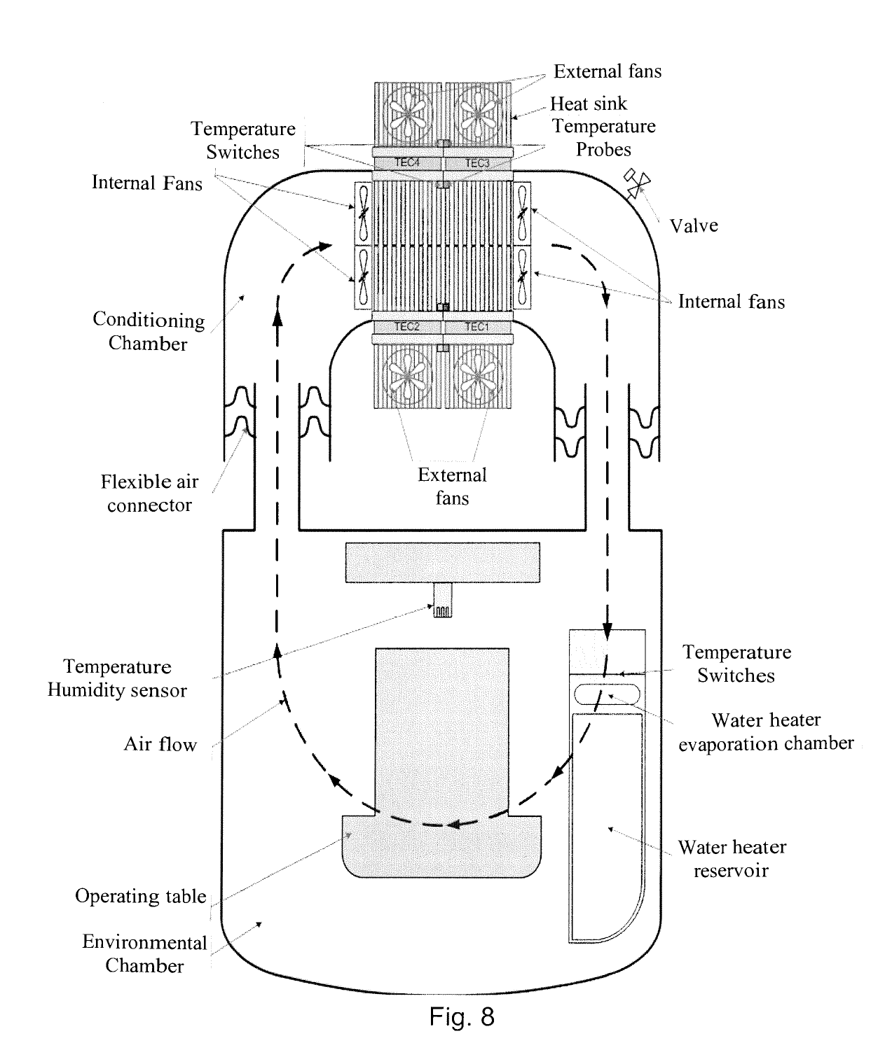

### FIGS. 8-12

FIG. 8 illustrates in cross-section another representative embodiment which comprises features and elements identified and further described herein. Embodiments such as that shown in FIG. 8 can be adapted to function with a larger instrument for fabrication, detection, or imaging.

Elements shown in FIG. 8 include:

A conditioning chamber adapted to function with an environmental chamber, wherein gaseous communication is established between the two chambers by flexible gas or air connectors. The conditioning chamber can provide a volume; the environmental chamber can provide a volume. The volume of the flexible gas or air connectors can be minimized.

TEC 1, TEC 2, TEC 3 and TEC 4 are heating-cooling devices, in this case thermoelectric devices, which provide a hot side and a cold side in operation. These thermoelectric devices are polarized to either heat or cool gas between opposing devices. A heater temperature probe functions together with a respective one of each of devices TEC 1-4. At least one heat sink (fins) is also provided with each of the thermoelectric devices, for example, as inner and/or outer heat sinks. At least one temperature switch may function together with at least one of a thermoelectric device, for example, at least one of TEC 1-4. The temperature switch can be adapted to cut off electric current to at least one of the thermoelectric devices when a maximum set-point temperature limit is reached. For example, a temperature switch may be adapted to cut off electric current to a thermoelectric device to which it is attached when the temperature equals or is greater than 85° C.

Four internal fans and four external fans may be included with the conditioning chamber. In one embodiment, the internal fans serve as gas transport devices providing gaseous flow from the conditioning chamber, through the environmental chamber and back to the conditioning chamber substantially in a clock-wise direction (when viewed from above). In one embodiment, gaseous transport provided by the internal fans is substantially unidirectional as indicated by the dashed arrow in the figure. In one embodiment, the unidirectional gaseous flow is provided by the fans such that gaseous flow in the environmental chamber is, for example, laminar in the environmental chamber and turbulent in the conditioning chamber. The external fans provide gaseous flow, for example, air flow, across the outer heat sinks.

A valve such as a solenoid valve is shown which, for lower humidity, can be activated so that humidity is decreased. Chamber air is displaced with gas such as nitrogen from an external source via the valve.

An operating table is shown which can be subjected to the flow of gas in a first direction or a second direction as shown by the arrows, the gas circulating between the conditioning chamber and the environmental chamber. The arrows show flow of air in a cooling mode, and flow of air in a heating mode. The operating table can be the site of a process like nanolithography or nanoscopic imaging.

Reversing the polarity on the thermoelectric devices switches between heating and cooling but does not reverse the direction of air circulation.

A temperature humidity sensor is also shown which can sense the environment around the operating table.

A water heater can also be placed in the flow of the gas to help with humidity control.

The environmental chamber can comprise a removable cover.

These and other elements are described in more detail hereinafter.

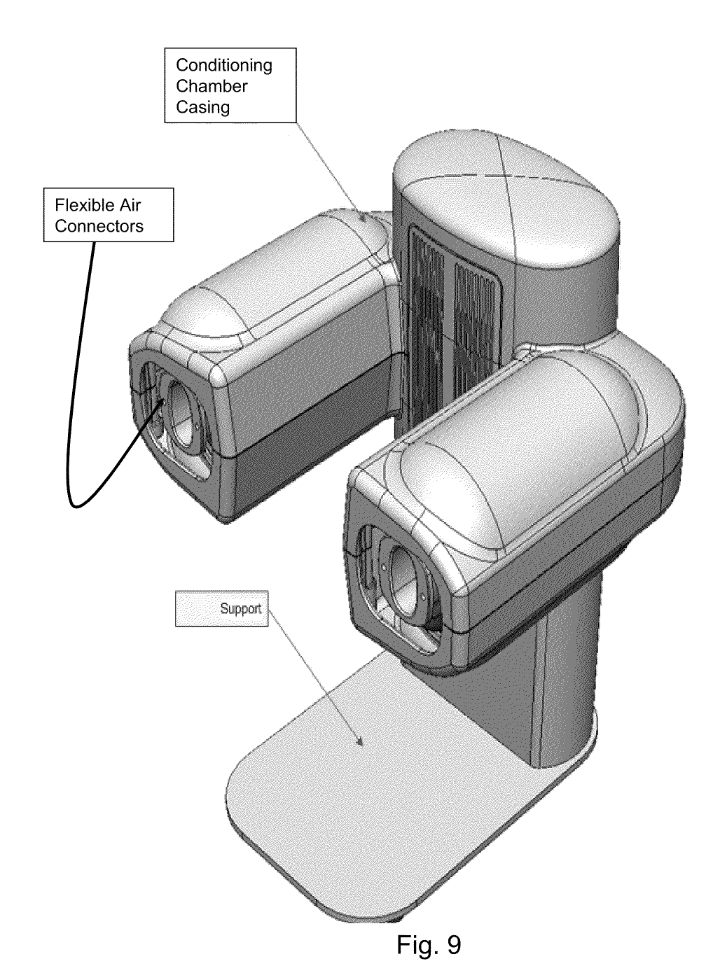

FIG. 9 provides a perspective view of another conditioning chamber embodiment. A support is shown which can be used below the conditioning chamber to position and stabilize the conditioning chamber. Flexible air connectors and other features of the conditioning chamber are not visible in this view.

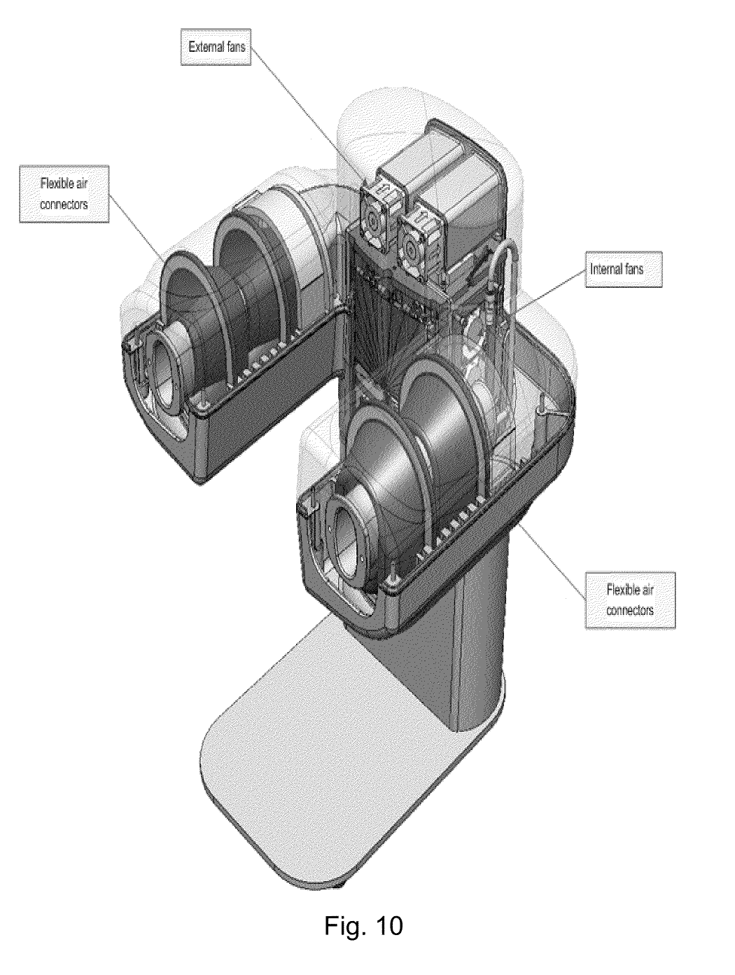

FIG. 10 provides a look into the inside of the conditioning chamber of FIG. 9 with an outer, including internal fans and flexible air connectors. The external fans are also visible.

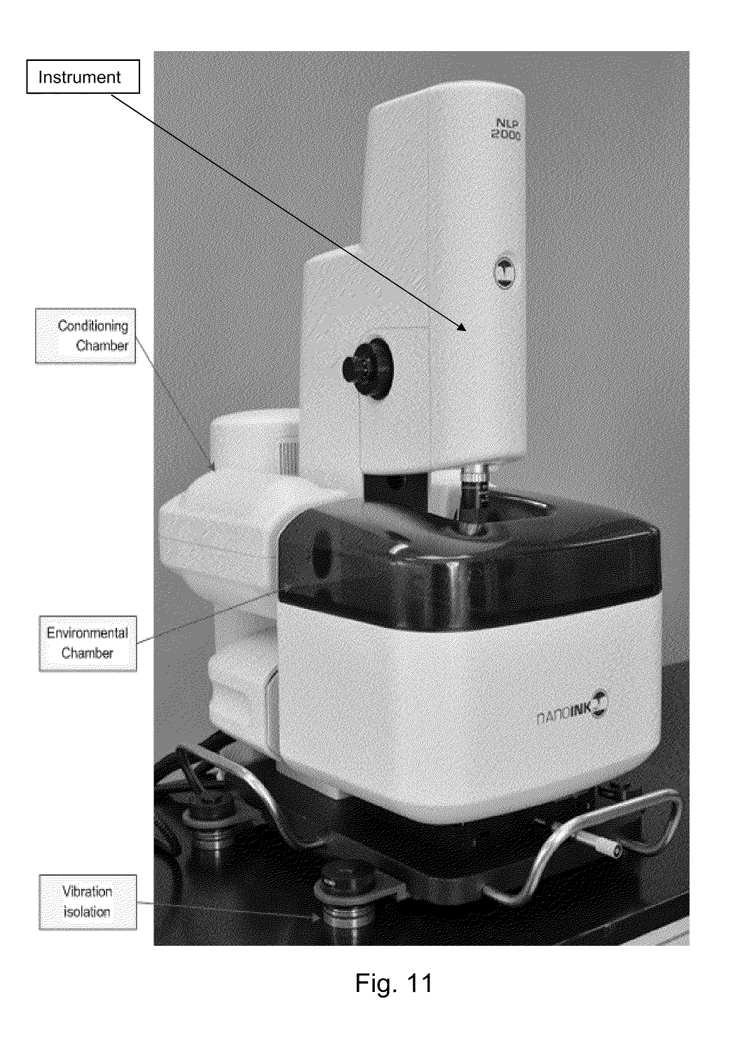

FIG. 11 shows another instrument which can be adapted to function with an environmental chamber and a conditioning chamber. The instrument can comprise, for example, optical microscopes to view specimens, positioning tables to maneuver a specimen relative to a microscope, and vibration isolation supports.

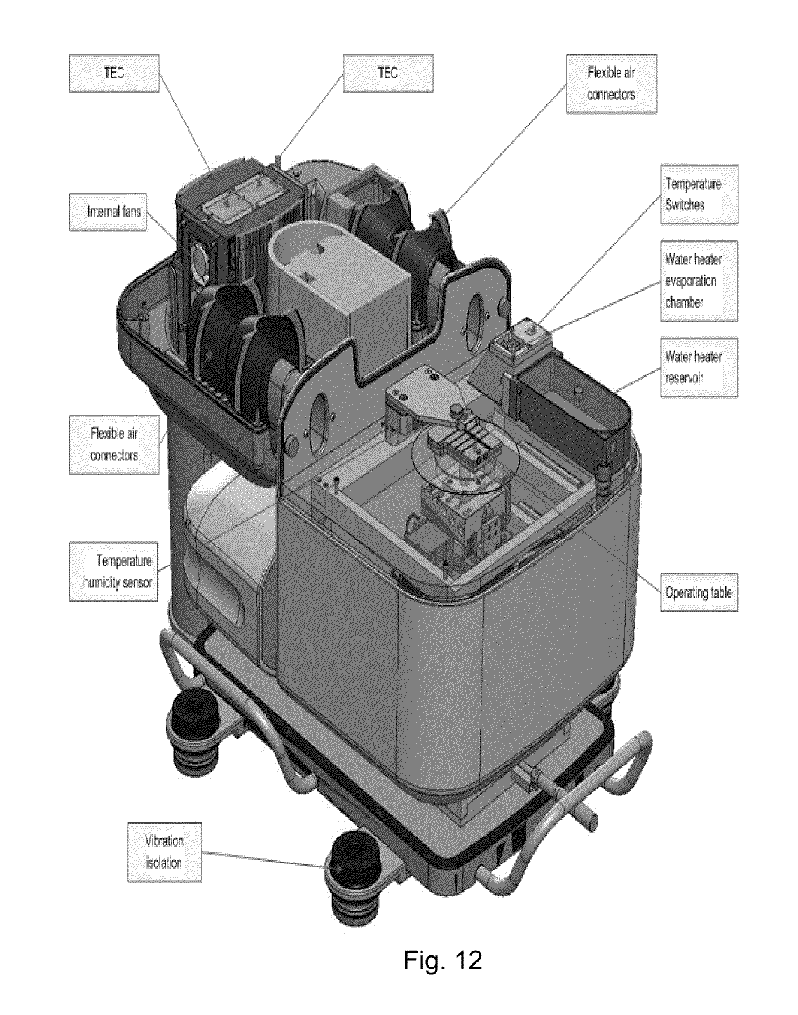

FIG. 12 provides a look into the inside of the instrument of FIG. 11, including internal fans, theremoelectric (TEC) devices, flexible air connectors, temperature switches, vapor source such as a water heater evaporation chamber, temperature/humidity sensor, operating table and vibration isolation supports.

### Conditioning Chamber

A conditioning chamber is generally known in the art. An example is shown in FIG. 1. Another example is shown in FIG. 8. The conditioning chamber can provide gaseous flow in one or more directions for circulation to and from the environmental chamber and facilitate temperature and humidity control. The conditioning chamber can comprise additional elements as described more below such as the gas transport device and the heating-cooling device. A gas transport device such as a fan can be external or internal, wherein internal devices and fans can be used to direct flow to the environmental chamber and the external devices and fans can be used for other purposes like removal of heat from heat sink. The conditioning chamber can be characterized by a conditioning chamber volume, and the volume can be minimized.

### Environmental Chamber

An environmental chamber is generally known in the art. An example is shown in FIG. 1. Another example is shown in FIG. 8. See also US Patent Publication 2009/0023607 filed May 9, 2008 to Rozhok et al. The environmental chamber can control the atmosphere around an operation such as a patterning experiment, a scanning probe experiment, an AFM experiment, or a nanolithography. See, for example, US Patent Publication 2009/0023607 filed May 9, 2008; U.S. Pat. No. 6,737,646 (Schwartz); U.S. Pat. No. 7,060,977 (Cruchon-Dupeyrat); U.S. Pat. No. 7,344,832 (Henderson); PCT publication WO 2006/076302 (Henderson). The environmental chamber can be adapted to enclose a pen assembly and a substrate. The chamber can be transparent and can be made of material like plastic or glass. Deposition of materials from nanoscopic and AFM tips to substrates can be executed and controlled in the environmental chamber. Gas composition can be also controlled. The environmental chamber can comprise an environmental chamber volume, which can be minimized.

### Gaseous Communication

The conditioning chamber and the environmental chamber can be in gaseous communication. For example, openings and/or passageways can connect the chambers and allow for movement of gases in and out of the chamber. The system can be set up with flexible materials to minimize vibrations. An example is shown in FIG. 1. Another example is shown in FIG. 8.

The environmental chamber and the conditioning chamber can be connected by at least one gas or air connector, which can be flexible if desired, which provides the gaseous communication. The environmental chamber and the conditioning chamber can be connected by at least two gas or air connectors which can be flexible if desired and each provide the gaseous communication.

The conditioning and environmental chambers can enclose relatively small volumes. Examples include 500 cc or less, or 200 cc or less, or 100 cc or less. Surface area of the combined volumes can be minimized.

### Gas Transport Device/Fan

A gas transport device such as, for example, a fan is known in the art and can function in continuous operation. The fan can be adapted to function with a heating-cooling device such as a thermoelectric device. A second different fan can be adapted to function with a different second thermoelectric device. Additional fans can each be adapted to function with one of additional thermoelectric devices.

In one embodiment, at least two fans transport gas in the same direction over a heating-cooling device. The two fans can work together simultaneously.

In another embodiment, a first fan can transport gas in one direction; a second fan can transport gas in an opposing direction, particularly when the first fan is not transporting gas.

In one embodiment, a single fan can be adapted to operate in two opposing directions, such as in a first direction to provide gaseous flow in a first flow direction, and adapted to operated in a second direction opposite the second direction to provide gaseous flow in a second flow direction, opposite the first flow direction. For example, the single fan capable of being operated in two opposing directions may be adapted to function with a first thermoelectric device acting as a heater and a second thermoelectric device acting as a cooler. In one operation mode, the single fan operates in a first direction to provide gaseous flow in a first flow direction toward the first thermoelectric device. In another operation mode, the single fan operates to provide gaseous flow in a second flow direction toward the second thermoelectric device. In this alternate embodiment, the first and second thermoelectric devices are each positioned on opposing sides of the single fan. A variable speed fan can be used, and speed used to control rate of heating and cooling.

In another embodiment, the conditioning chamber can comprise at least 8 gas transport devices which are fans, with 4 of the 8 fans being external fans and the other 4 fans being internal fans. The fans can be adapted to provide substantially unidirectional gaseous flow from the conditioning chamber to the environmental chamber.

The at least one gas transport device, first volume and second volume are adapted to provide gaseous flow at a different velocity in the environmental chamber than in the conditioning chamber

### Heating-Cooler Device/Thermoelectric Device

Heating and cooling devices can comprise various forms of heat exchanger which may be adapted for heating and cooling of a gaseous medium. In a preferred embodiment, at least one of a heating-cooling device can comprise, for example, a thermoelectric device. Thermoelectric devices are known in the art including, for example, thermoelectric coolers, otherwise known as Peltier diodes or Peltier heat pumps. A heating-cooling device and a thermoelectric device can have a hot side and a cold side in operation. One thermoelectric device can function to heat; another thermoelectric device can function to cool. Hot and cold side of the thermoelectric device can be reversed by reversing polarity of the applied voltage. In other words, a thermoelectric device can be adapted for acting as a heater when operated at a first polarity, and as a cooler when operated at a second polarity opposite the first polarity.

Fins can facilitate heat exchange.

### Temperature Probe/Sensor in Conditioning Chamber

Temperature probes and sensors are known in the art including low resolution and high resolution temperature probes. In an embodiment, one temperature probe can function with one heating-cooling device such as a thermoelectric device to detect, for example, excessive heating and provide a warning for over temperature fail safe conditions and, for example, generate an alarm. Another temperature probe can function with another heating-cooling device such as a thermoelectric device to facilitate, cooling. These can be low resolution temperature probes.

In one embodiment, a first temperature probe can be embedded on a hot side of a heating-cooling device such as a thermoelectric device.

In another embodiment, a second temperature probe can be embedded on a hot side of a heating-cooling device such as a thermoelectric device.

In another embodiment, a first and a second temperature probe can be embedded on a hot side of a first and second heating-cooling device such as a first and second thermoelectric device.

### Water Vapor Source

A water vapor source can be used to help control humidity levels. For example, a water vapor source can be disposed in the environmental chamber. The water vapor source can be used with a water heater which when activated can increase humidity by heat induced surface evaporation and/or by boiling. The heater may be connected to a temperature switch.

### Temperature Probe/Sensor in Environmental Chamber

A temperature probe or sensor can be disposed in the environmental chamber. The temperature probe or sensor can provide feedback about the conditions in an operation area. This temperature probe can be used to can drive the heating-cooling device to achieve a desired thermal condition. This probe can be a high resolution temperature probe. The temperature probe or sensor in the environmental chamber may also operate as a temperature and humidity probe or sensor.

### Operating Device

An operating device including an operating table can be disposed in the environmental chamber and subject to the temperature controlled and humidity controlled gaseous flow. The device such as a table can be adapted to execute fabrication, nanolithography, detection, imaging, and other functions and applications described herein. The table can be moved in three dimensions or at different angles.

### Operation Area

An operation area can be designated in the environmental chamber to execute functions such as patterning, lithography, imaging, or other kinds of fabrication and analysis. The operation area can be adapted for direct write lithography including direct write nanolithography, including DPN® printing.

### Humidity Sensor

A humidity sensor can be disposed in the environmental chamber. The humidity sensor can provide feedback about the conditions in the operation area. The humidity sensor may also operate as a temperature and humidity sensor.

### Valve

A valve can be used such as a solenoid valve to flush a system with gas such as, for example, nitrogen or dry nitrogen from an external source. The valve can be in the conditioning chamber, as shown in FIGS. 1 and 8.

### Temperature Control

The environment surrounding an operation area in the environmental chamber can be temperature controlled.

For example, the environmental chamber can provide a heating temperature range which can be, for example, ambient to plus 20° C. In other words, the environmental chamber can provide a heating temperature range which can be, for example, from ambient to 20° C. above ambient. In another embodiment, the environmental chamber can provide a heating temperature range which can be, for example, from ambient to 40° C. above ambient. Ambient can be, for example, 20° C. or 25° C.

Or, the environmental chamber can provide a cooling temperature range which can be, for example, ambient to minus 2° C. In other words, the environmental chamber can provide a cooling temperature range which can be, for example, from ambient to 2° C. below ambient. In another embodiment, the environmental chamber can provide a a cooling temperature range which can be, for example, from ambient to 15° C. below ambient.

The environmental chamber can provide a temperature stability which can be, for example, ±0.5° C.

In one embodiment, temperature control of an environmental chamber can be achieved by circulating air through a conditioning chamber. For example, if heating is desired, a heating-cooling device such as a thermoelectric device can operate in conjunction with a gas transport device such as a fan. If cooling is desired, a thermoelectric device can operate in conjunction with a fan. Switching from heating to cooling can reverse direction of air circulation in the environmental chamber.

In one embodiment, the control of temperature can be carried out in one of two modes: manual and automatic.

### Humidity Control

The operation area in the environmental chamber can also be subjected to humidity control.

Devices and concepts for humidity control are known in the art. See, for example, U.S. Pat. No. 7,008,769 (Henderson).

The environmental chamber can provide a humidity range which can be, for example, 5%-90% relative humidity, non-condensing.

The environmental chamber can provide a humidity stability which can be, for example, ±2.5% relative humidity.

The humidity stability can be automatically or manually controlled. For higher humidity, a water heater can be activated, which can increase humidity by heat induced surface evaporation and/or by boiling. For lower humidity, a valve such as a solenoid valve can be activated, decreasing humidity by displacing chamber air with gas such as nitrogen or dry nitrogen from an external source.

The different elements described herein can be coupled with a user interface to provide excellent control over temperature, humidity, or both.

### Software and User Interface

Software and user interfaces and other computer implementations can be adapted and are known in the art. The user interface can be designed to have different modes of operation including for temperature and/or humidity control. For example, in one embodiment, three modes of operation are built into the software and user interface including an off mode, a manual mode, and an automatic mode.

The user interface can provide, for example, controls for displaying current conditions such as any one or more of the following:
temperature in environmental chamber,
humidity in environmental chamber,
a first fan (a gas transport device) velocity
a second fan (a gas transport device) velocity
a temperature in a first thermoelectric device (a heating-cooling device)
a temperature in a second thermoelectric device (a heating-cooling device)

Fan velocities or speeds can be controlled in tandem or separately.

The user interface controls can be utilized for system control:
control to switch between modes such as off mode, manual mode, automatic mode,
control to switch between HEAT and COOL
control to input target temperature for automatic mode
control to input power level when in manual mode
control to set fan speed for manual mode
control to turn valve ON and OFF
control to turn water heater ON and OFF

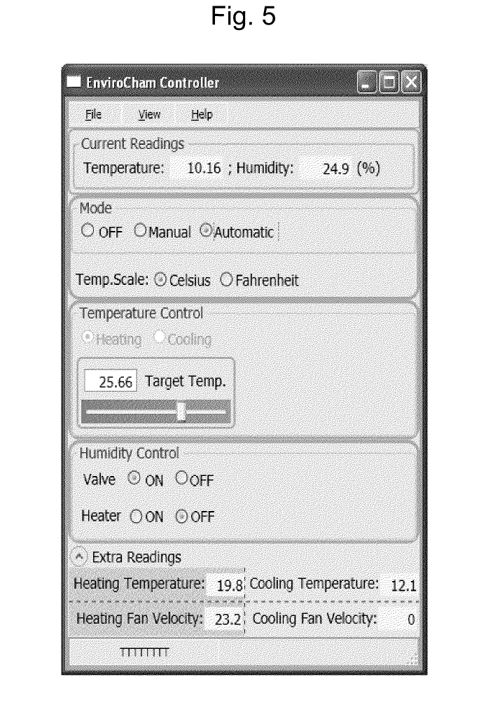

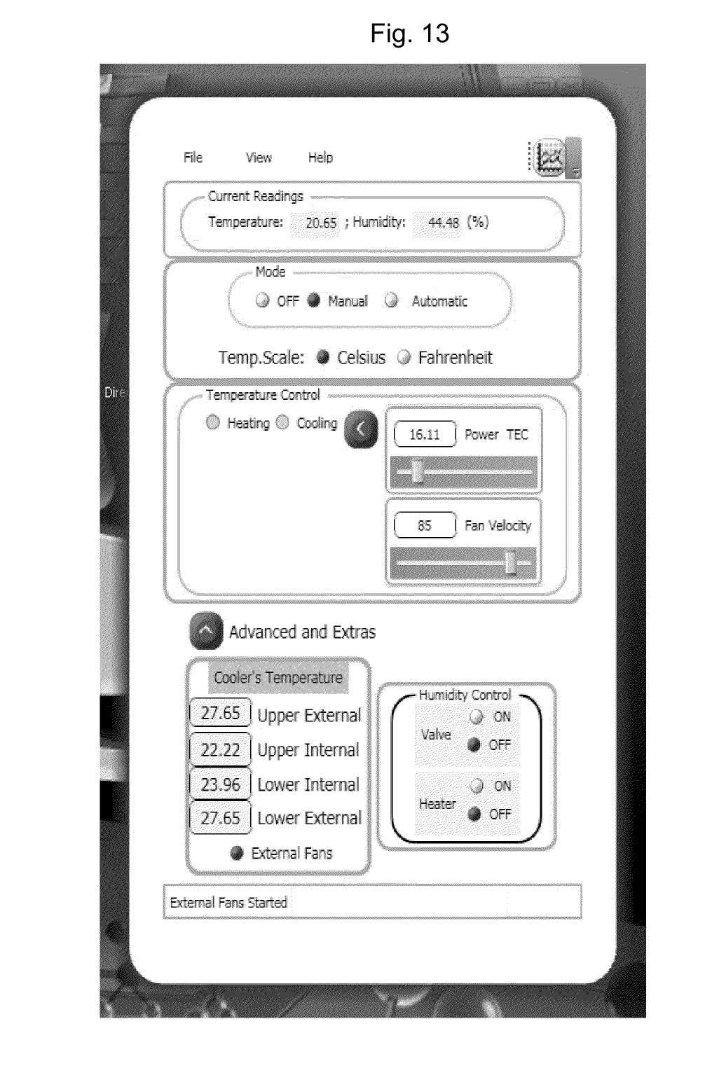

FIGS. 5-7 illustrate examples of user interfaces for different modes. These embodiments can be used to function with the system illustrated in FIG. 1. FIGS. 13-15 illustrate examples of user interfaces for different modes. These embodiments can be used to function with the system illustrated in FIG. 8. The screen can show, for example, the current temperature and humidity readings; the mode it is in such as off, manual, or automatic; the temperature control such as heating or cooling and the target temperature, and the humidity control including valve and heater function. Extra readings like heating and cooling temperature and heating and cooling fan velocity can be, optionally, displayed or hidden.

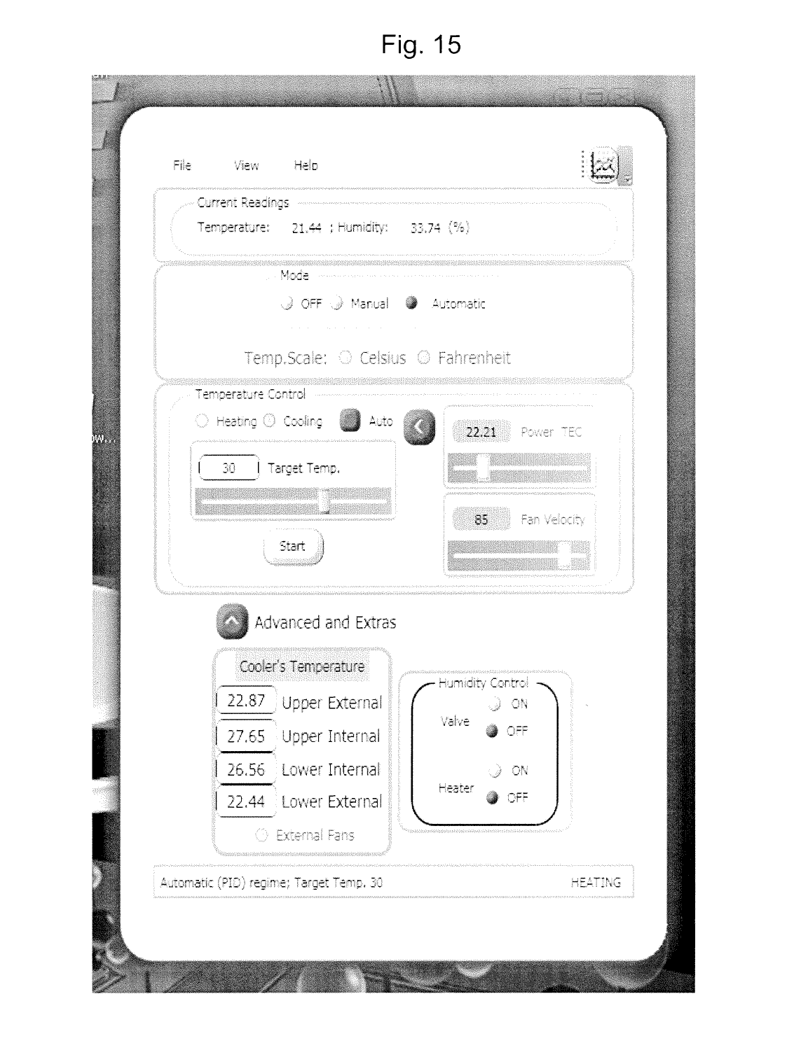

In some embodiments, temperature control can be executed in automatic mode. See, for example, FIGS. 5 and 15. In one step, a user can switch the system into automatic mode. In another step, a user can set a target temperature. In another step, the system can ramp the temperature to the target, for example, until the environmental chamber temperature is stabilized. In one embodiment, the environmental chamber's temperature is considered stabilized when it is within 0.1 degrees of the target temperature and the temperature control loop derivative is small. Once stabilized, the internal fan velocity may decrease to a predetermined minimum to hold the temperature at the target. During this ramping period, the balance between heat differential on thermoelectric device and fan velocity can be executed with preference to lower velocity. In another step, the system can maintain target temperature with a lowest possible level of fan velocity. During this maintaining period, the fan velocity can be changed minimally or not at all unless necessary.

A PID loop can provide control loop feedback to correct an error between a measured process variable and a desired set point by calculating and then outputting a corrective action that can adjust the process accordingly. For example, a PID loop can provide control loop feedback between measured temperature and humidity values at a target site, and a controller such as a computer which controls the fan velocity and power to a thermoelectric heater and cooler device. Thereby, a PID loop can be exercised over induced heat differential. The system can maintain a target temperature until it is changed or until an automatic mode is off.

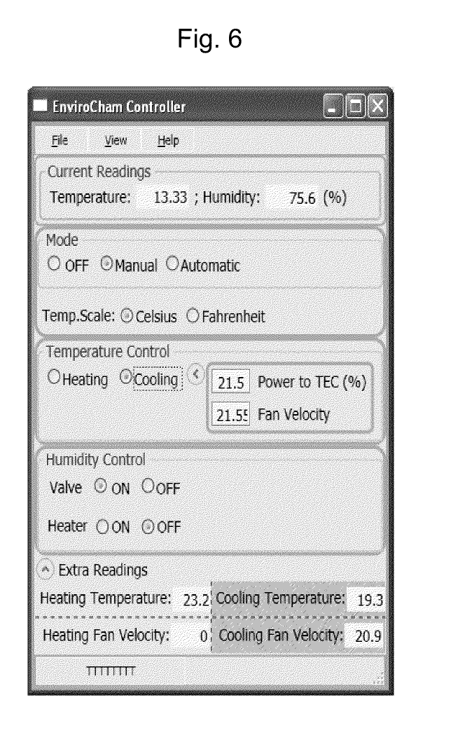

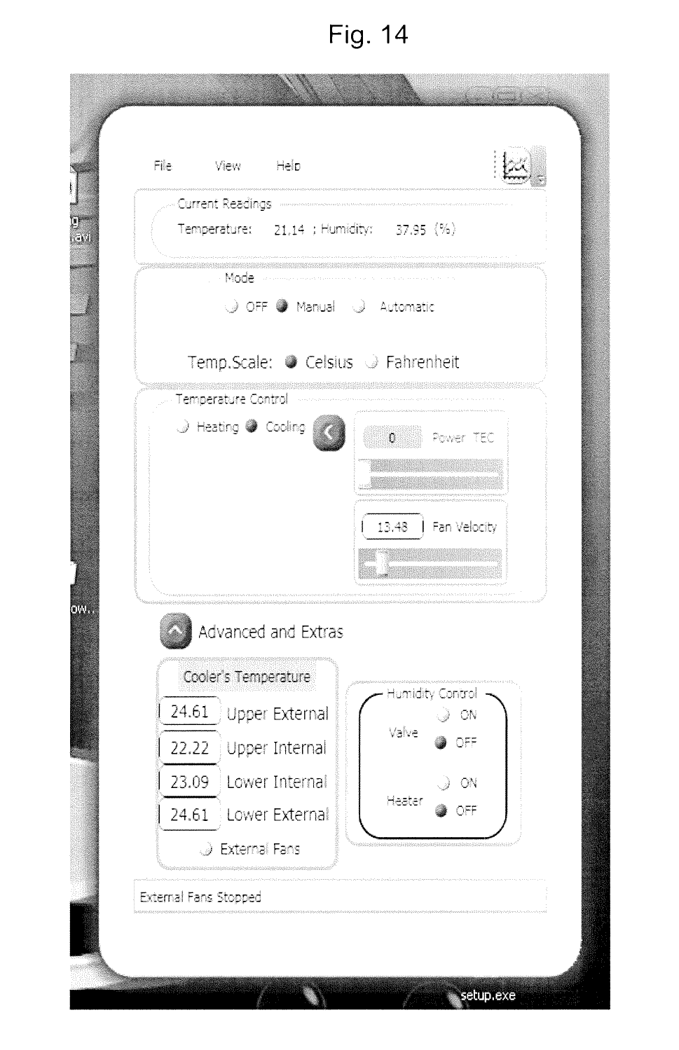

In some embodiments, temperature control can be executed in manual mode. See, for example, FIGS. 6 and 14. For example, in one step a user can switch the system to manual mode. The user can choose a heat or cool mode. In another step, the user can set a level of power, such as a percentage, applied to the thermoelectric device. In another step, the user can set a fan velocity. In another step, the system can maintain set parameters until they are changed or until manual mode is turned off.

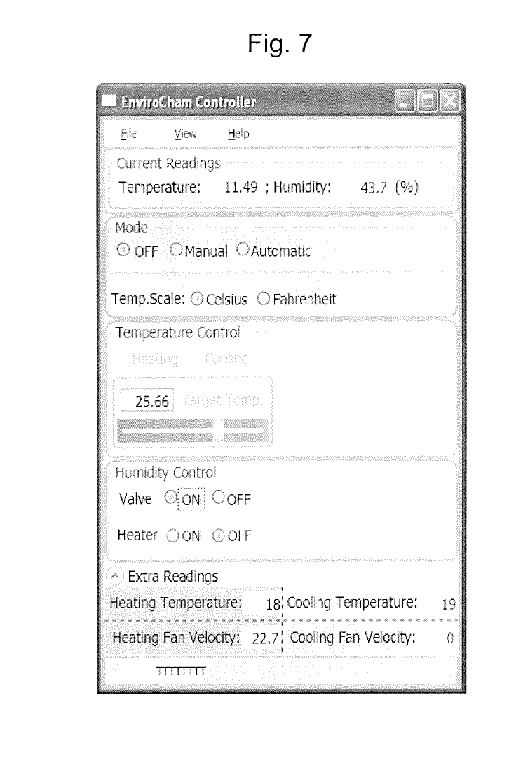

In one embodiment, temperature control can be executed in off mode. See, for example, FIG. 7. Here, the system displays current temperature.

In one embodiment the user can start up the system to begin controlling temperature. For example, in one step a user can switch the system to start up and the system starts up in manual mode. See, for example, FIG. 13. When the system starts up, both external and internal fans can be started.

In another embodiment, humidity control can be executed. In one step, readout from humidity sensor can be provided for the user. In another step, user can turn on the heat for water bath to increase humidity. No closed loop control can be present. In another step, a user flushes a chamber with nitrogen, dry nitrogen, or other gas to decrease humidity. No closed loop control can be present.

### Methods of Making

The components can be assembled by methods known in the art. Components can be individually provided and then assembled to form a final device. A final device can be assembled to be used with a larger instrument.

### Methods of Using and Applications

One method of use comprises a method comprising: providing an operation area and gaseous flow over the operation area, wherein the gaseous flow controls the temperature and humidity of the operation area, wherein the gaseous flow is provided by at least one fan in continuous operation for cooling and heating and adapted to function with at least one thermoelectric cooler and at least one water vapor source. In one step, gaseous flow can occur over an operation area while gas is being heated. Then, gaseous flow can occur in the opposite direction over an operation area while gas is being cooled. Flow can be switched back and forth between heating and cooling modes.

In one embodiment, a heating-cooling device, such as a thermoelectric device, can be used which provides a hot and a cold side, and the polarity can be switched so cold and hot are switched. If polarity is switched, one heating-cooling device can be used.

Other examples of methods of use and applications that can be adapted with use of the embodiments described herein for an environmental control device are described in U.S. Pat. No. 7,361,310 granted on Apr. 22, 2008 to Mirkin, et al. (“Direct Write Nanolithographic Deposition of Nucleic Acids From Nanoscopic Tips), US Patent Application Publication 2003-0068446 filed on Oct. 2, 2002 to Mirkin, et al. (Protein and Peptide Nanoarrays), US Patent Application Publication 2005-0009206 filed on Mar. 1, 2004 to Mirkin, et al. (Peptide and Protein Arrays and Direct-Write Lithographic Printing of Peptides and Proteins), and U.S. Pat. No. 7,569,340 granted on Aug. 4, 2009 to Mirkin, et al. (Nanoarrays of Single Virus Particles, Methods and Instrumentation for the Fabrication and Use Thereof), all of which are hereby incorporated by reference in their entireties.

### Detecting/Imaging

Detecting and imaging methods are known in the art including, for example, optical devices such as microscopes and non-optical devices such as probe-based methods including scanning probe methods such as those utilizing scanning probe microscopes. Scanning probe microscopes (SPMs) can be used to obtain extremely detailed analyses of the topographical or other features of a surface, with sensitivities extending down to the scale of individual atoms and molecules. SPMs can scan a probe over a sample surface and make local measurements of the properties of the sample surface. Several components are common to practically all scanning probe microscopes. An important component of the microscope is a tiny probe positioned in very close proximity to a sample surface and providing a measurement of its topography or some other physical parameter, with a resolution that is determined primarily by the shape of the tip and its proximity to the surface. In a scanning force microscope (SFM), the probe includes a tip which projects from the end of a cantilever. Typically, the tip is very sharp to achieve maximum lateral resolution by confining the force interaction to the end of the tip. One common example of an SPM is the atomic force microscope (AFM), also known as the scanning force microscope (SFM). By measuring motion, position or angle of the free end of the cantilever, many properties of a surface may be determined including surface topography, local adhesion, friction, elasticity, the presence of magnetic or electric fields, and the like. In operation, an AFM typically will scan the tip of the probe over the sample while keeping the force of the tip on the surface constant, such as by moving either the base of the lever or the sample upward or downward to maintain deflection of the lever portion of the probe constant. Therefore, the topography of a sample may be obtained from data on such vertical motion to construct three dimensional images of the surface topography. Further details of SPMs are described in, for example, U.S. Pat. Nos. 5,025,658 and 5,224,376, the entire disclosures of which are incorporated herein by reference.

### Patterning/Fabrication

Patterning and fabrication methods are known in the art and are used in, for example, nanolithography. Microfabrication can be used to selectively remove parts of a thin film or the bulk of a substrate, or add materials. The process utilizes a photomask placed over the material to be removed which allows light to transfer to a light-sensitive chemical known as a photoresist which is formed on the substrate. A series of chemical treatments then engraves an exposure pattern into the material underneath the photoresist. Photolithographic methods and devices are described in Hummel, R.; “Electronic properties of materials” 3^{rd} Ed., Springer-Verlag New York, Inc., 2001, and also in Wolf et al. “Silicon processing for the VLSI era. Vol. 1, Process technology”, 2^{nd} Ed. Lattice Press 1999.

### Patterning/Nanolithography

Patterning and nanolithography methods, such as direct-write technologies, are known in the art and include dip pen nanolithography (DPN®). DPN and DIP PEN NANOLITHOGRAPHY are trademarks of NanoInk, Inc. and are used accordingly herein. In the DPN printing process, an ink is transferred to a substrate from a tip. The transferred ink, if desired, can be used as a template for further fabrication. The advantages and applications for DPN printing are numerous and described in these references. DPN printing is an enabling nanofabrication/nanolithographic technology which allows one to practice fabrication and lithography at the nanometer level with exceptional control and versatility. Present embodiments enable the preparation of surfaces patterned with discrete catalyst materials at nanometer scale and nanometer resolution with facile control. DPN printing provides for fine control of the patterning which is not provided by other methods. However, DPN printing can also be automated which provides rapid production. Moreover, the structures produced by DPN printing are generally stable, as DPN printing allows for the catalysts to be covalently bonded or chemically adsorbed to the substrate rather than merely physically adsorbed or mechanically locked in. DPN printing does not require that the substrate surface be made porous to accept the catalyst in a mechanical lock. Rather, the strategically patterned catalyst materials, chemically bound at predefined locations by DPN printing, are then used for growing desired materials such as, for example, carbon nanotubes at the predefined locations on the substrate. Additional information on dip pen nanolithogaphic techniques may be found in documents such as Jaschke M et al. “Deposition of Organic Material by the Tip of a Scanning Force Microscope,” Langmuir, 1995, 11, 1061-1064, and Piner et al. “Dip Pen Nanolithography,” Science, 1999, 283, 661-663, which are hereby incorporated by reference in their entirety. See also U.S. Pat. No. 6,827,979 to Mirkin et al.

Another example of a use can be found in Lenhert et al, “Massively Parallel Dip-Pen Nanolithography of Heterogeneous Supported Phospholipid Multilayer Patterns,” Small, 2007, 3, No. 1, 71-75, which is hereby incorporated by reference and noting references cited therein.

### EXAMPLES

Embodiments described in the present application, therefore, provide an article capable of being adapted to compliment systems including those that incorporate methods such as lithography techniques, including nanolithography methods, for example such as e-beam direct writing (EBDW), focused ion beam (FIB) and probe-based nanolithographies, such as DIP PEN NANO LITHOGRAPHY™ (DPN) printing (proprietary marks of NanoInk, Inc., Skokie, Ill., providing consulting, products, and services related to nanolithography) and scanning tunneling microscopy (STM)-based nanolithographies, as well as micron-level lithography methods, such as conventional optical lithography.

Further examples of instruments to which embodiments may be adapted to compliment include, but are not limited to, probe nanomanipulators, such as an atomic force microscope (AFM), a scanning tunneling microscope, or a tool dedicated to nanolithography, such as the Nanolnk DPN writer P1OO and its successors, (available from NanoInk, Inc., Chicago, Ill.) and electron- or ion-based lithography means, such as scanning electron microscopes (SEM), (scanning) transmission electron microscopes, and focused ion beam mills, including the tools branded by Raith, LEO, Jeol, Hitachi, FEI and Veeco. The instruments can also include micron level lithographic devices, such as conventional optical lithography devices.

What is claimed is:

1. An article comprising:
at least one environmental chamber;
at least one conditioning chamber adapted to be in gaseous communication with the environmental chamber,
wherein the conditioning chamber comprises at least one gas transport device, and at least one heating-cooling device which in operation provides a cold side and a hot side,
at least one water vapor source, and
at least one temperature sensor,
at least one humidity sensor,
wherein the gas transport device, the heating-cooling device, the water vapor source, the temperature sensor, and the humidity sensor are adapted for a temperature controlled and humidity controlled gaseous flow in the environmental chamber.

2. The article of claim 1, wherein the heating-cooling device comprises a thermoelectric device.

3. The article of claim 1, wherein the gas transport device comprises a fan.

4. The article of claim 1, wherein the water vapor source comprises a water heater.

5. The article of claim 1, wherein the conditioning chamber comprises at least one gas transport device which is a fan, and at least one heating-cooling device which is a thermoelectric heater.

6. The article of claim 1, wherein the conditioning chamber comprises at least two gas transport devices which are fans, and at least two heating-cooling devices which are thermoelectric heaters.

7. The article of claim 1, wherein the environmental chamber and the conditioning chamber are connected by at least one gas connector which provides the gaseous communication.

8. The article of claim 1, wherein the environmental chamber and the conditioning chamber are connected by at least two gas connectors which each provide the gaseous communication.

9. The article of claim 1, wherein an operating device is disposed in the environmental chamber and is subject to the temperature controlled and humidity controlled gaseous flow in the environmental chamber.

10. The article of claim 1, wherein the environmental chamber is not hermetically sealed and the conditioning chamber is not hermetically sealed.

11. The article of claim 1, wherein the temperature sensor is a high resolution temperature sensor.

12. The article of claim 1, wherein the conditioning chamber comprises at least one valve adapted to decrease humidity in a gaseous flow.

13. The article of claim 1, wherein an operating device is disposed in the environmental chamber which is adapted for patterning, nanolithography, detection, imaging, or a combination thereof.

14. The article of claim 1, wherein the environmental chamber comprises a removable cover.

15. The article of claim 1, wherein the environmental chamber and conditioning chamber together comprise a volume less than about 200 cubic cm.

16. The article of claim 1, wherein the article is adapted for substantially continuous gaseous exchange between the environmental chamber and the conditioning chamber.

17. The article of claim 1, wherein the article is adapted for a flow of air in a cooling mode and a flow of air in a heating mode.

18. The article of claim 1, wherein the article is adapted to function with a computer and a user interface.

19. The article of claim 1, wherein temperature sensor and the humidity sensor are disposed in the environmental chamber.

20. The article of claim 1, wherein a first gas transport device and a second gas transport device are each disposed between a first heating-cooling device and a second heating-cooling device.

21. An article comprising:
at least one environmental chamber;
at least one conditioning chamber adapted to be in gaseous communication with the environmental chamber,
wherein the conditioning chamber comprises at least one gas transport device, and at least one heating-cooling device which in operation provides a cold side and a hot side,
at least one water vapor source, and
at least one temperature sensor,
at least one humidity sensor,
wherein the gas transport device, the heating-cooling device, the water vapor source, the temperature sensor, and the humidity sensor are adapted for a temperature controlled gaseous flow in the environmental chamber.

22. An article comprising:
at least one environmental chamber;
at least one conditioning chamber adapted to be in gaseous communication with the environmental chamber,
wherein the conditioning chamber comprises at least one gas transport device, and at least one heating-cooling device which in operation provides a cold side and a hot side,
at least one water vapor source, and
at least one temperature sensor,
at least one humidity sensor,
wherein the gas transport device, the heating-cooling device, the water vapor source, the temperature sensor, and the humidity sensor are adapted for a humidity controlled gaseous flow in the environmental chamber.

23. An article comprising:
at least one environmental chamber at least one conditioning chamber adapted to be in gaseous communication with the environmental chamber,
wherein the conditioning chamber comprises at least one fan and at least one thermoelectric device,
at least one water vapor source, which can be disposed in the environmental chamber or the conditioning chamber, and
at least one temperature sensor disposed in the environmental chamber, at least one humidity sensor disposed in the environmental chamber,
wherein the environmental chamber is adapted to function with at least one operation area disposed in the environmental chamber;
wherein the fan, the thermoelectric device, the water vapor source, the temperature sensor, and the humidity sensor are adapted for a temperature controlled and humidity controlled gaseous flow at the operation area in the environmental chamber.

24. The article of claim 23, wherein the article comprises at least two fans.

25. The article of claim 23, wherein the article comprises at least two thermoelectric devices and at least two temperature probes associated with the two thermoelectric devices.

26. The article of claim 23, wherein an operation device is disposed in the environmental chamber and subjected to temperature and humidity controlled gaseous flow.

27. The article of claim 23, wherein the article is adapted for use with a nanolithography instrument.

28. The article of claim 23, wherein the article is adapted to function with a computer and a user interface.

29. The article of claim 23, wherein the volume of the environmental chamber and conditioning chamber combined is about 200 cc or less.

30. The article of claim 23, wherein the thermoelectric device is capable of acting as a heater when operated with a first electrical polarity and as a cooler when operated with a second electrical polarity, said second polarity being of opposite the first electrical polarity.

31. An instrument comprising:
at least one conditioning chamber,
at least one environmental chamber,
at least one temperature control system,
at least one humidity control system, and an operation area,
wherein the chambers and systems are adapted for closed loop control via software to control temperature and humidity during an operation in the operation area.

32. The instrument of claim 31, wherein the instrument is adapted to function with a system comprising a microscope.

33. The instrument of claim 31, wherein the instrument is adapted to function with a patterning system.

34. The instrument of claim 31, wherein the instrument is adapted to function with a nanolithography system.

35. A method comprising:
providing an operation area and gaseous flow over the operation area, wherein the gaseous flow controls the temperature and humidity of the operation area, wherein the gaseous flow is provided by at least one gas transport device in continuous operation for cooling and heating and adapted to function with at least one heating-cooling device, and at least one water vapor source.

36. The method of claim 35, wherein the gaseous flow is provided by two fans, wherein only one of said two fans is in operation at a given time, and each of said two fans provide gaseous flow in opposite directions when in operation.

37. The method of claim 35, wherein the gaseous flow is provided by two fans, wherein the two fans are in operation at the same time, and each of said two fans provide gaseous flow in the same direction when in operation.

38. The method of claim 35, wherein the gaseous flow is provided by one fan, and said fan is capable of providing gaseous flow in a first direction when operated with a first electrical polarity and said fan capable of providing gaseous flow in a second direction when operated with a second electrical polarity, said second polarity being opposite said first polarity.

39. A user interface adapted to function with the article of claim 1.

40. The article of claim 1, wherein the conditioning chamber comprises at least eight gas transport devices which are fans, and at least four heating-cooling devices which are thermoelectric heaters, wherein four of the fans are internal fans and four of the fans are external fans.

41. The article of claim 1, wherein the conditioning chamber provides a first volume, the environmental chamber provides a second volume in gaseous communication with the first volume, and
wherein the at least one gas transport device, first volume and second volume are adapted to provide gaseous flow at a different velocity in the environmental chamber than in the conditioning chamber.

42. The article of claim 1, wherein an operating device is disposed in the environmental chamber which is adapted for printing biomolecules.
